(19) United States
(12) Patent Application Publication
(10) Pub. No.: US 2007/0077464 A1
(43) Pub. Date: Apr. 5, 2007

(54) METHOD OF CONTROLLING FUEL CONCENTRATION IN A DIRECT LIQUID FUEL CELL

(76) Inventors: FENG-YI DENG, Taipei (TW); YU-JEN CHIU, Taipei (TW)

Correspondence Address: G. LINK CO., LTD., 3550 BELL ROAD, MINOOKA, IL, 60447, US

(21) Appl. No.: 11/537,870

(22) Filed: Oct. 2, 2006

(30) Foreign Application Priority Data
Oct. 4, 2005 (TW) 094134588

(51) Int. Cl. H01M 8/10

(52) U.S. Cl. 429/13; 429/32

(57) ABSTRACT

A method of controlling fuel concentration in a direct liquid fuel cell is disclosed. In step 101, a direct liquid fuel cell including a first set of membrane electrode assemblies and a second set of membrane electrode assemblies is provided. In step 103, anodic liquid fuels with a known, low-limited concentration are injected into the second set of membrane electrode assemblies such that the second set of membrane electrode assemblies performs electrochemical reactions and generates a first current (I₁) at a regular output voltage. Then, the I₁ is recorded. In step 105, anodic liquid fuels with an unknown concentration are injected into the first set of membrane electrode assemblies and the second set of membrane electrode assemblies such that the second set of membrane electrode assemblies performs electrochemical reactions and generates a third current (I₃) at the regular output voltage; wherein the anodic liquid fuels with an unknown concentration injected into the second set of membrane electrode assemblies are maintained at the same temperature as the temperature of the anodic liquid fuels with a known, low-limited concentration from step 103. In step 107, the concentration of the anodic liquid fuels from step 105 is increased, if I₃≦I₁+ε, where ε represents a concentration tolerance.

### FIELD OF THE INVENTION

The present invention relates to a concentration meter, and more particularly, to a method of controlling fuel concentration, which is applied to a direct liquid fuel cell.

### BACKGROUND OF THE INVENTION

Conventionally, the fuel concentration of a direct liquid fuel cell, such as a direct methanol fuel cell (DMFC), is measured by a concentration sensor. However, the concentration sensor needs to be scaled down for a more compact direct liquid fuel cell. Otherwise, it is not possible to dispose the concentration sensor into a miniaturized direct liquid fuel cell even though such sensor can detect the concentration of fuels. In addition, the concentration meter may detect fuel concentration inaccurately after a long period of time due to the variation of electrochemical properties.

In view of the aforesaid disadvantage, a method to control fuel concentration in a direct liquid fuel cell is provided, by which the membrane electrode assembly of the direct liquid fuel cell is used as a concentration sensor.

### SUMMARY OF THE INVENTION

It is a primary object of the invention to provide a method for sensing the concentration of anodic liquid fuels in a direct liquid fuel cell, which can measure the concentration of fuels in a direct liquid fuel cell during electrochemical reactions.

In accordance with the aforesaid object of the invention, a method of controlling fuel concentration in a direct liquid fuel cell is provided, which comprises the following steps. In step 101, a direct liquid fuel cell is provided: wherein the direct liquid fuel cell comprises a first set of membrane electrode assemblies and a second set of membrane electrode assemblies, the first set of membrane electrode assemblies provides currents for a loading, and the second set of membrane electrode assemblies functions as a sensor for detecting the concentration of anodic liquid fuels. In step 103, anodic liquid fuels with a knoan, low-limited concentration are injected into the second set of membrane electrode assemblies such that the second set of membrane electrode assemblies performs electrochemical reactions and generates a first current at a regular output voltage. Then, a value for the first current is recorded after the first current is stable. In step 105, anodic liquid fuels with an unknown concentration are injected into the first set of membrane electrode assemblies and the second set of membrane electrode assemblies such that the second set of membrane electrode assemblies performs electrochemical reactions and generates a third current at the regular output voltage; wherein the anodic liquid fuels with an unknown concentration injected into the second set of membrane electrode assemblies are maintained at the same temperature as the temperature of the anodic liquid fuels with a known, low-limited concentration from step 103. In step 107, the concentration of the anodic liquid fuels from step 105 is increased, and the concentrated anodic liquid fuels with an unknown concentration are injected into the first set of membrane electrode assemblies and the second set of membrane electrode assemblies if I₃≦I₁+ε, where I₁ represents the first current, I₃ represents the third current, and ε represents a concentration tolerance.

### BRIEF DESCRIPTION OF THE DRAWINGS

These and other modifications and advantages will become even more apparent from the following detained description of a preferred embodiment of the invention and from the drawings in which:

FIG. 1 is a flow chart depicting fuel concentration control in a direct liquid fuel cell system according to one embodiment of the invention;

FIG. 2 schematically illustrates a direct liquid fuel cell system, which performs the method of controlling fuel concentration according to one embodiment of the invention;

FIG. 3 schematically illustrates a direct liquid fuel cell system, which performs step (103) of the method for controlling fuel concentration according to one embodiment of the invention;

FIG. 4 schematically illustrates a direct liquid fuel cell system, which performs step (105) of the method for controlling fuel concentration according to one embodiment of the invention;

FIG. 5 schematically illustrates a direct liquid fuel cell system, which performs step (107) of the method for controlling fuel con-centration according to one embodiment of the invention; and

FIG. 6 schematically illustrates a direct liquid fuel cell system, which ordinarily performs the method of controlling fuel concentration according to one embodiment of the invention.

### DETAILED DESCRIPTION OF THE INVENTION

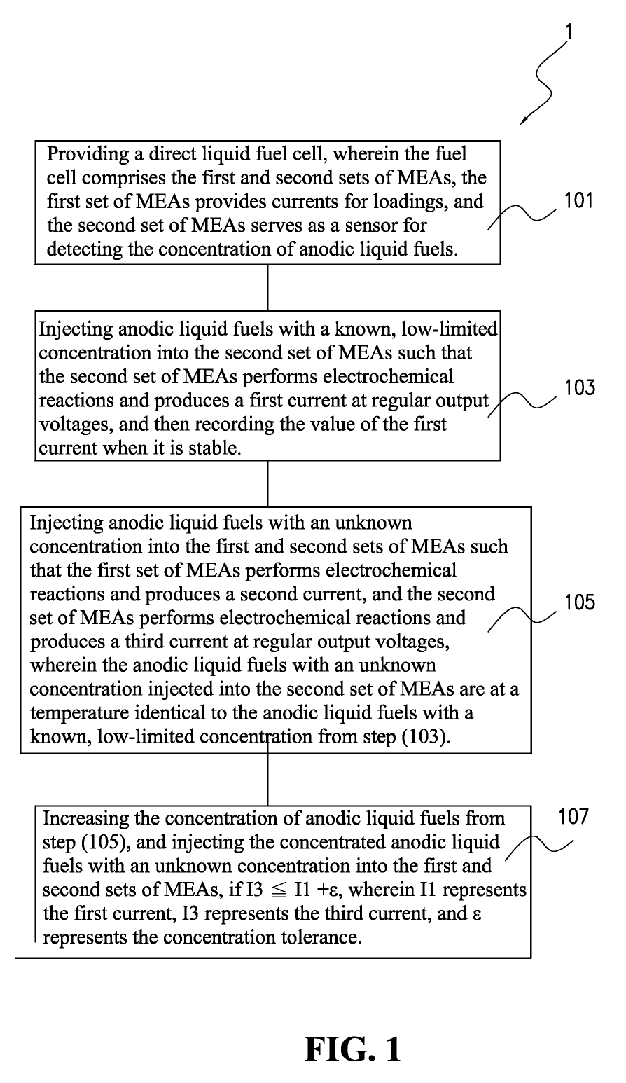

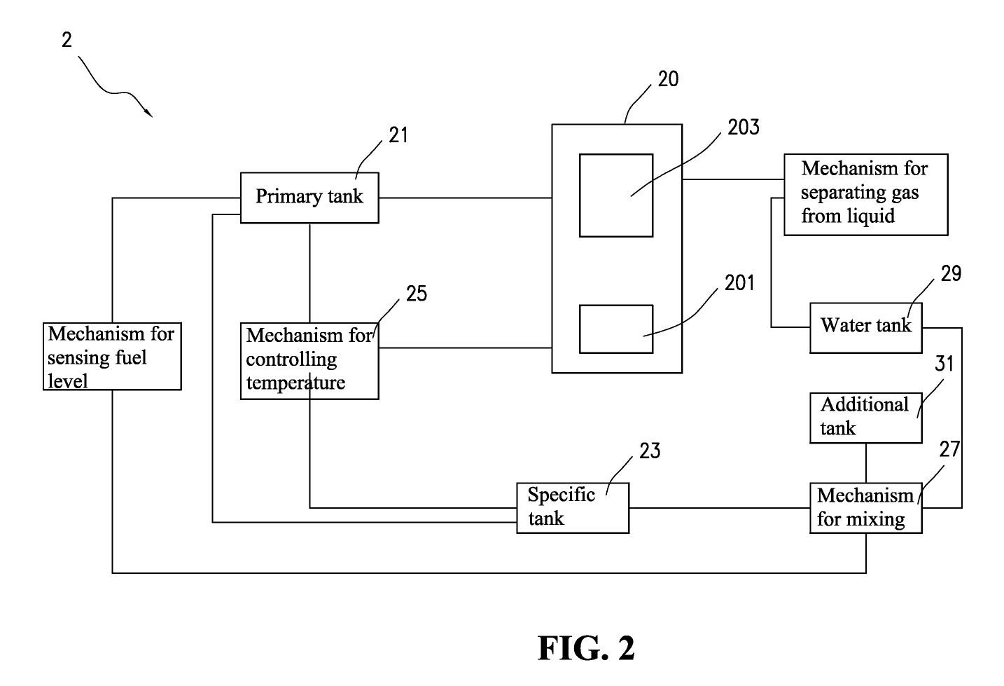

FIG. 1 is a flow chart depicting fuel concentration control in a direct liquid fuel cell system according to one embodiment of the invention. FIG. 2 schematically illustrates a direct liquid fuel cell system, which implements the method of controlling fuel concentration according to one embodiment of the invention. In one embodiment, the second set of membrane electrode assemblies (MEAs) 201 is used as a sensor for detecting the concentration of anodic liquid fuels such that the method 1 of controlling fuel concentration can control the then concentration of anodic liquid fuels in the direct liquid fuel cell 20. The method 1 includes steps 101-107. which are separately described hereinafter.

Referring to FIG. 2, a mechanism for separating gas from liquid is provided to collect anode products from the first set of MEAs 203 and the second set of MEAs 201, and to exhaust gas from the anode products, leaving liquid anode products. According to the invention, such liquid anode products can be recycled and reused. A mechanism for sensing fuel level is provided to detect the level of anodic liquid fuels inside the primary tank 21.

In step 101, a direct liquid fuel cell 20 is provided. The direct liquid fuel cell 20 includes a first set of MEAs 203 and a second set of MEAs 201. The first set of MEAs 203 may include one or more MEAs. Thereby, the first set of MEAs 203 may be configured as a stacked or planar fuel cell. The second set of MEAs 201 may include one or more MEAs. If the second set of MEAs 201 is composed of two or more MEAs, then the positives and negatives of the MEAs are connected in series or in parallel. In this embodiment, only one MEA is illustrated in the second set of MEAs 201 for clarification.

Referring to the direct liquid fuel cell system 2 in FIG. 2, the first set of MEAs 203 performs electrochemical reactions immediately and provides currents for external loadings after receiving air and anodic liquid fuels in the primary tank 21, As for the second set of MEAs 201, air, anodic liquid fuels within the specific tank 23 or anodic liquid fuels within the primary tank 21 are maintained at a predetermined temperature by the mechanism for controlling temperature 25 before injection into the second set of MEAs 201. When supplied with air and anodic liquid fuels, the second set of MEAs 201 performs electrochemical reactions immediately and produces a first current and a third current.

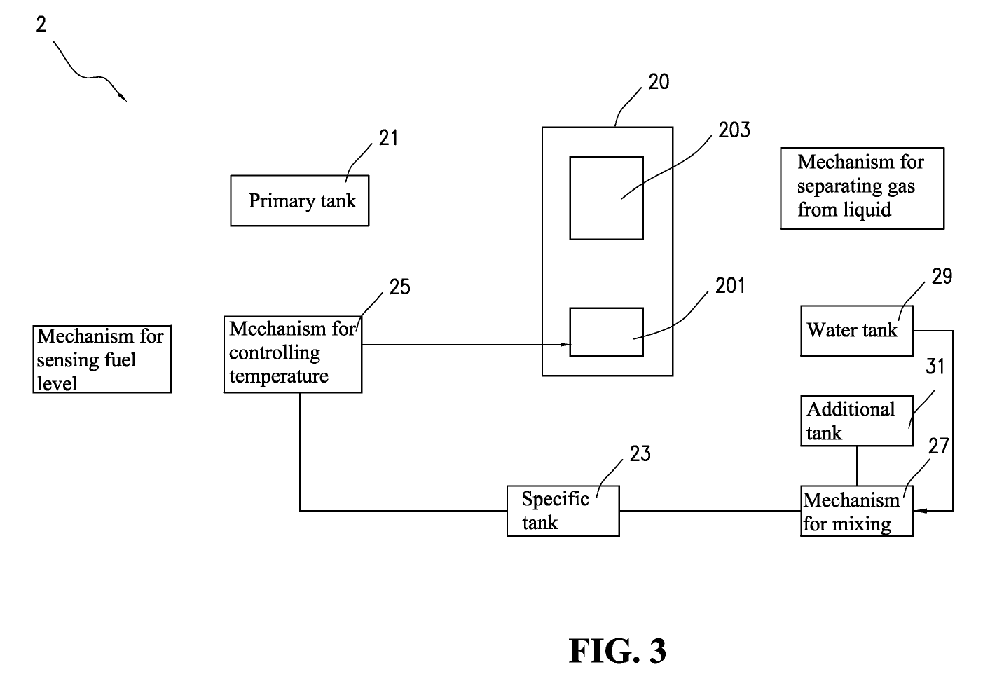

In step 103, anodic liquid fuels with a known, low-limited concentration are injected into the second set of MEAs 201 so that the second set of MEAs 201 performs electrochemical reactions and generates a first current at regular output voltages. The value of the first current I₁, is not recorded until it is stable. FIG. 3 shows a direct liquid fuel cell system, which performs step 103. Water in the water tank 29 and anodic liquid fuels with high concentrations in the additional tank 31 are mixed by the mechanism for mixing 27 to make the concentration of mixed anodic liquid fuels range between known, low-limited values. In one embodiment, anodic liquid fuels may be a methanol solution, and a methanol solution of 3v % is delivered to the specific tank 23, As the direct liquid fuel cell system 2 executes step 103, anodic liquid fuels with a known, low-limited concentration from the specific tank 23 are processed by the mechanism for controlling temperature 25 and maintained at a temperature of 40° C., for example. The anodic liquid fuels with a known, low-limited concentration at 40° C. are then injected into the second set of MEAs 201. Meanwhile, output voltages at the positives and negatives of the second set of MEAs 201 are steadied to be regular voltages, such as 0.3 volts. Accordingly, the second set of MEAs 201 outputs a first current with constant voltage on the condition of outputting regular voltages. Once the first current is stable, the direct liquid fuel cell system 2 records the value of the first current I₁.

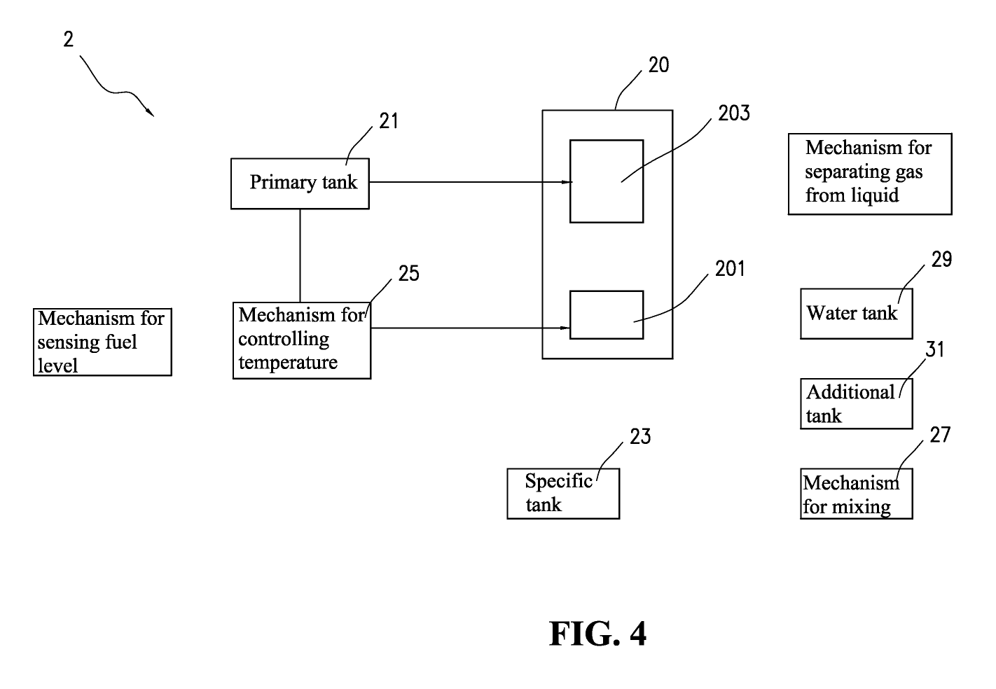

In step 105, anodic liquid fuels with an unknown concentration are injected into the first set of MEAs 203 and the second set of MEAs 201 so that the first set of MEAs 203 performs electrochemical reactions and generates a second current, and the second set of MEAs 201 performs electrochemical reactions and generates a third current at regular output voltages. The temperature of the anodic liquid fuels with an unknown concentration is identical to that of the anodic liquid fuels with a known, low-limited concentration in step 103. FIG. 4 shows a direct liquid fuel cell system performing step 105. The primary tank 21 contains anodic liquid fuels with an unknown concentration. Anodic liquid fuels with an unknown concentration in the primary tank 21 are injected into the first set of MEAs 203 and the mechanism for controlling temperature 25, respectively. The mechanism for controlling temperature 25 keeps the anodic liquid fuels at the same temperature as the temperature of the anodic liquid fuels with a known, low-limited concentration, for example, at 40° C. Anodic liquid fuels with an unknown concentration at 40° C. are next injected into the second set of MEAs 201. Meanwhile, output voltages at the positives and negatives of the second set of MEAs 201 are steadied to be regular voltages, such as 0.3 volts. As such, the second set of MFAs 201 outputs a third current with constant voltage at consistent output voltages. Additionally, the direct liquid fuel cell system 2 records the value of the third current I₃ constantly.

In step 105, the first set of MFAs 203 performs electrochemical reactions and generates a second current, and thus provides power for loadings.

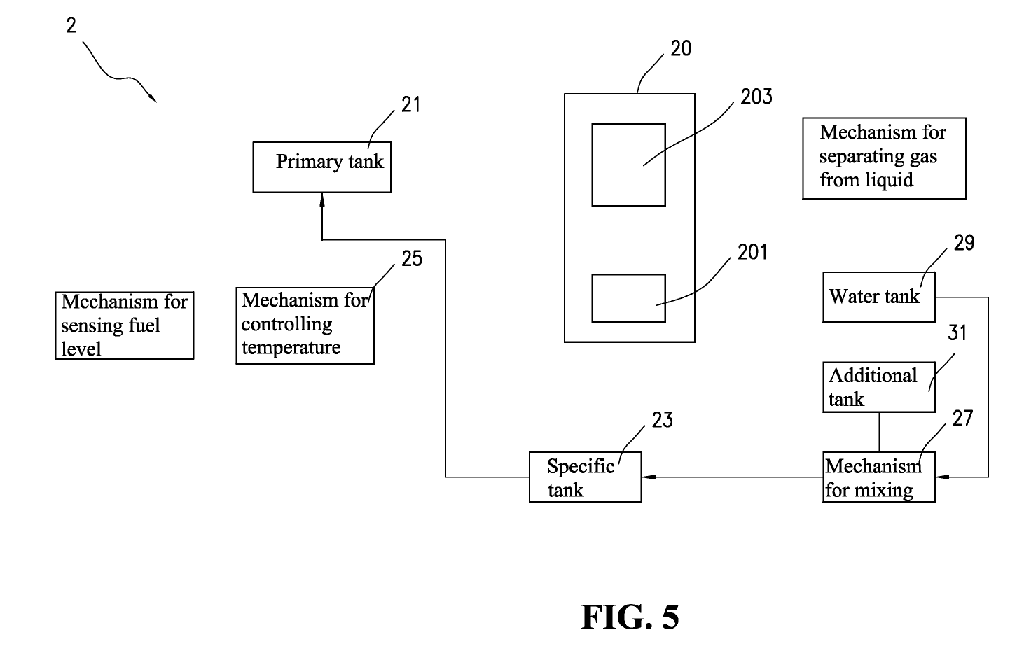

In step 107, if I₃≦I₁+ε, then the concentration of the anodic liquid fuels from step 105 is increased, and thereafter the concentrated anodic liquid fuels with an unknown concentration are injected into the first set of MEAs 203 and the second set of MEAs 201; wherein I₁ represents the first current, I₃ represents the third current, and ε represents a concentration tolerance that equals zero or above. FIG. 5 shows a direct liquid fuel cell system performing step 107. Water in the water tank 29 and anodic liquid fuels with a high concentration in the additional tank 31 are mixed by the mechanism for mixing 27 until the concentration of the mixed anodic liquid fuels is higher than that of the anodic liquid fuels with an unknown concentration in the primary tank 21. The concentrated anodic liquid fuels mixed by the mechanism for mixing 27 are injected into the primary tank 217 so as to increase the concentration of the anodic liquid fuels with an unknown concentration therein.

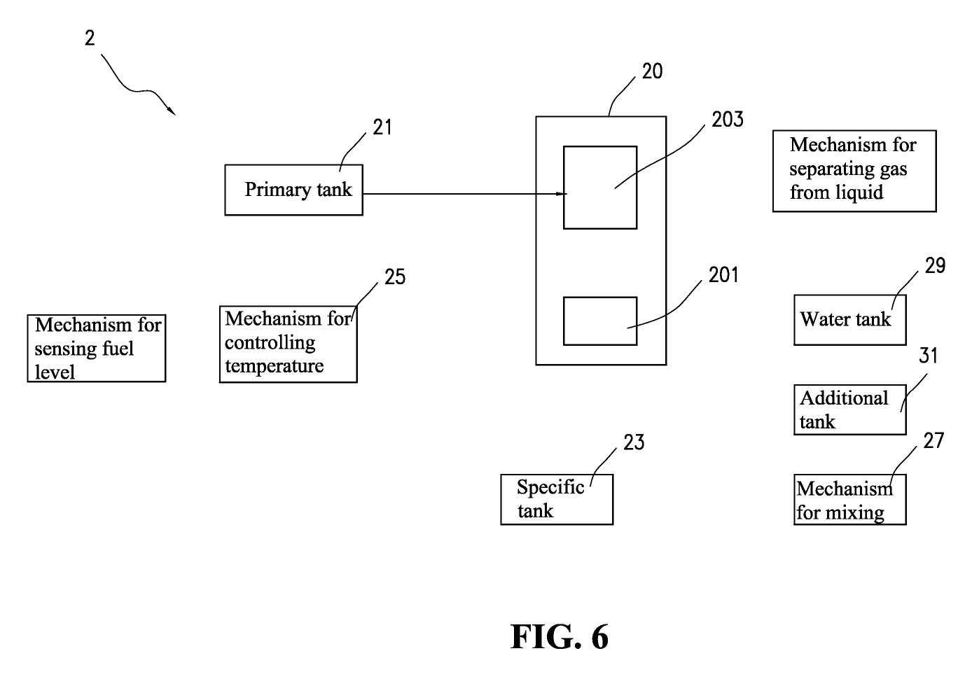

FIG. 6 illustrates a direct liquid fuel cell system in ordinary operation. If the direct liquid fuel cell system 2 does not implement the method 1, the anodic liquid fuels from the primary tank 21 are injected into the first set of MEAs 203. As soon as the first set of MEAs 203 receives air and anodic liquid fuels, the first set of MEAs 203 performs electrochemical reactions and provides currents for external loadings. Since the direct liquid fuel cell system 2 does not execute the method 1, the second set of MEAs 201 may not perform electrochemical reactions.

The anodic liquid fuels may be methanol, ethanol, or dimethoxymethane (DMM). The exemplary anodic liquid fuels are illustrated as examples only, which are not intended to limit the scope of the invention. Other anodic liquid fuels may be applied to the embodiments of the invention, of course.

The method 1 of controlling fuel concentration uses MEAs as a concentration sensor, which senses the concentration variation of the anodic liquid fuels by the difference in currents. Also, the method 1 regards the first current induced by the fuels with a low-limited concentration as a reference to exclude measuring errors resulting from changes in the properties of the MEAs. Hence, the concentration of fuels is controlled effectively according to the invention.

While the invention has been particularly shown and described with reference to the preferred embodiments thereof, these are, of course, merely examples to help clarify the invention and are not intended to limit the invention. It will be understood by those skilled in the art that various changes, modifications, and alterations in form and details may be made therein without departing from the spirit and scope of the invention, as set forth in the following claims.

What is claimed is:

1. A method of controlling fuel concentration in a direct liquid fuel cell, the method comprising the following steps of:
(A) providing a direct liquid fuel cell, wherein the direct liquid fuel cell comprises a first set of membrane electrode assemblies and a second set of membrane electrode assemblies, the first set of membrane electrode assemblies provides currents for a loading, and the second set of membrane electrode assemblies functions as a sensor for detecting a concentration of anodic liquid fuels;
(B) injecting anodic liquid fuels with a known, low-limited concentration into the second set of membrane electrode assemblies such that the second set of membrane electrode assemblies performs electrochemical reactions and generates a first current at a regular output voltage, and then recording a value for the first current after the first current is stable;
(C) injecting anodic liquid fuels with an unknown concentration into the first set of membrane electrode assemblies and the second set of membrane electrode assemblies such that the second set of membrane electrode assemblies performs electrochemical reactions and generates a third current at the regular output voltage, wherein the anodic liquid fuels with an unknown concentration injected into the second set of membrane electrode assemblies is maintained at the same temperature as the temperature of the anodic liquid fuels with a known, low-limited concentration from the step (B); and
(D) increasing the concentration of the anodic liquid fuels from step (C), and injecting the concentrated anodic liquid fuels with an unknown concentration into the first set of membrane electrode assemblies and the second set of membrane electrode assemblies, if I₃≦I₁+ε, wherein I₁ represents the first current, I₃ represents the third current, and ε represents a concentration tolerance.

2. The method of claim 1, wherein the first set of membrane electrode assemblies comprises one or more membrane electrode assemblies.

3. The method of claim 1, wherein the second set of membrane electrode assemblies comprises only one membrane electrode assembly.

4. The method of claim 1, wherein the second set of membrane electrode assemblies comprises one or more membrane electrode assemblies.

5. The method of claim 1, wherein the known, low-limited concentration of the anodic liquid fuels in the step (B) ranges between 2 v % and 8 v %.

6. The method of claim 1, wherein at the regular output voltage, the second set of membrane electrode assemblies produces a constant voltage.

7. The method of claim 6, wherein the constant voltage is from 0.1 volts to 0.6 volts.

8. The method of claim 1, wherein the anodic liquid fuels with a known, low-limited concentration are maintained at a temperature of 20° C. to 80° C.

9. The method of claim 1, wherein the anodic liquid fuels with an unknown concentration are maintained at a temperature of 20° C. to 80° C.

10. The method of claim 1, wherein the concentration tolerance, ε, is equal to zero or greater than zero.

11. The method of claim 1, wherein the anodic liquid fuels are methanol, ethanol, or dimethoxymethane (DMM).

12. The method of claim 1, wherein in step (C), the first set of membrane electrode assemblies further performs electrochemical reactions and generates a second current, and the second current is provided for the loading.
